(19) United States
(12) Patent Application Publication
(10) Pub. No.: US 2026/0329275 A1
(43) Pub. Date: Oct. 22, 2026

(54) CONTROL APPARATUS

(71) Applicant: TOYOTA JIDOSHA KABUSHIKI KAISHA, Aichi-ken (JP)

(72) Inventor: Nobuyuki MATSUNO, Tokyo-to (JP)

(21) Appl. No.: 19/529,118

(22) Filed: Feb. 4, 2026

(30) Foreign Application Priority Data
Feb. 12, 2025 (JP) 2025-021110

(51) Int. Cl. G05D 1/224; G05D 1/622; G05D 105/10; G05D 107/70; G05D 109/10; G05D 111/10

(52) U.S. Cl. CPC G05D 1/2247; G05D 1/622; G05D 2105/10; G05D 2107/70; G05D 2109/10; G05D 2111/10

(57) ABSTRACT

A control apparatus includes a communication interface that communicates with a mobile object, and a controller that outputs information for displaying a planned travel path of the mobile object superimposed on a captured image ahead in a travel direction of the mobile object. The length of the planned travel path corresponds to a first movement speed when the movement speed of the mobile object is the first movement speed, and is a predetermined length when the movement speed is a second movement speed that is less than the first movement speed.

### CROSS-REFERENCE TO RELATED APPLICATION

This application claims priority to Japanese Patent Application No. 2025-021110, filed on Feb. 12, 2025, the entire contents of which are incorporated herein by reference.

### TECHNICAL FIELD

The present disclosure relates to a control apparatus.

### BACKGROUND

Various technologies for remotely controlling mobile objects such as traveling robots have been proposed. For example, Patent Literature (PTL) 1 discloses a technology for displaying a marker indicating a target position for which a mobile object is heading, in a remote control apparatus.

### CITATION LIST

### Patent Literature

PTL 1: JP 2014-106576 A

### SUMMARY

Although the difficulty of remote control varies depending on the environment around the movement paths, the movement speeds, and the like of mobile objects, there is room for improvement in the operability of remote control of the mobile objects.

Hereinafter, a control apparatus and the like that enable improvement in the operability of remote control of a mobile object will be disclosed.

A control apparatus according to the present disclosure includes:
a communication interface configured to communicate with a mobile object; and
a controller configured to output information for displaying a planned travel path of the mobile object superimposed on a captured image ahead in a travel direction of the mobile object,
wherein the length of the planned travel path corresponds to a first movement speed when the movement speed of the mobile object is the first movement speed, and is a predetermined length when the movement speed is a second movement speed that is less than the first movement speed.

The control apparatus according to the present disclosure can improve the operability of remote control of a mobile object.

### BRIEF DESCRIPTION OF THE DRAWINGS

In the accompanying drawings:

FIG. 1 is a diagram illustrating an example of a configuration of a remote control system;

FIG. 2A is a sequence diagram illustrating an example operation procedure of the remote control system;

FIG. 2B is a sequence diagram illustrating an example operation procedure of the remote control system;

FIG. 3A is a diagram illustrating an example of a screen for operation;

FIG. 3B is a diagram illustrating an example of the screen for operation;

FIG. 3C is a diagram illustrating an example of the screen for operation;

FIG. 4A is a diagram explaining the length of a planned travel path; and

FIG. 4B is a diagram explaining the length of the planned travel path.

### DETAILED DESCRIPTION

An embodiment will be described below.

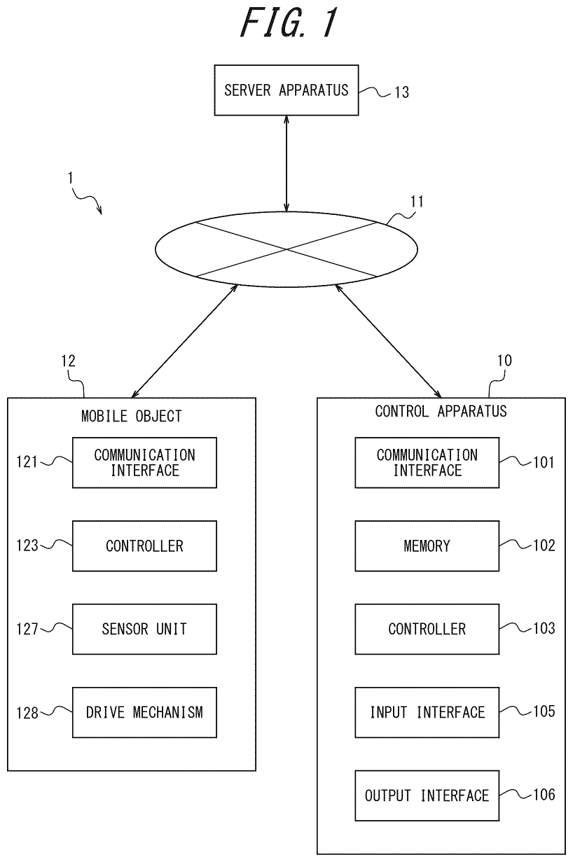

FIG. 1 is a diagram illustrating an example configuration of a remote control system according to the embodiment. The remote control system 1 includes a mobile object 12 and a control apparatus 10 for remotely controlling the mobile object 12. The mobile object 12 and the control apparatus 10 are connected to each other communicably via the network 11 through the mediation of the server apparatus 13. The mobile object 12 is, for example, a traveling robot for transporting goods in a warehouse, commercial facility, etc. The control apparatus 10 is an information processing apparatus equipped with communication functions and an interface for user operation, for example, a PC (personal computer), smartphone terminal, tablet terminal, or an operation terminal for the mobile object 12. The network 11 may, for example, be the Internet, but may also include an ad hoc network, a local area network (LAN), a metropolitan area network (MAN), or other networks or any combination thereof. The server apparatus 13 is a server computer belonging to a cloud computing system or other computing system, for example, and implements various functions.

In the remote control system 1 of this embodiment, the control apparatus 10 has a communication interface 101 for communicating with the mobile object 12 and a controller 103 that outputs information for displaying the planned travel path of the mobile object 12 superimposed on a captured image ahead in the travel direction (hereinafter referred to as the forward image). Here, the length of the displayed planned travel path is a length corresponding to the first movement speed when the movement speed of the mobile object 12 is the first movement speed, and a predetermined length when the movement speed is a second movement speed smaller than the first movement speed. When the control apparatus 10 displays the forward image of the mobile object 12 to the user and accepts remote control of the mobile object 12 by the user, by displaying the planned travel path on the forward image, the user can confirm the presence or absence of obstacles around the planned travel path of the mobile object 12 in advance. At this time, by displaying the length of the planned travel path longer as the movement speed of the mobile object 12 is greater and shorter as the movement speed is smaller, the user can always confirm the planned travel path that the mobile object 12 can reach in a certain time, for example, after 1 to several seconds, regardless of the movement speed of the mobile object 12. However, when the speed of the mobile object 12 becomes small to a certain extent, for example, in cases requiring careful operation, the length of the planned travel path is displayed fixedly longer than the length corresponding to the movement speed of the mobile object 12, ensuring the predictability of the planned travel path for the user. Therefore, it becomes possible to improve the operability in the remote control of the mobile object 12.

As shown in FIG. 1, the control apparatus 10 includes a communication interface 101, a memory 102, a controller 103, an input interface 105, and an output interface 106.

The communication interface 101 is equipped with a module compliant with communication standards such as wired LAN, wireless LAN, LTE (Long Term Evolution), 4G (4th Generation), and 5G (5th Generation), and connects to the network 11 via a router or base station. Through the communication interface 101, the control apparatus 10 performs information communication with the mobile object 12 via the server apparatus 13 through the network 11.

The memory 102 includes a semiconductor memory, a magnetic memory, or an optical memory. The semiconductor memory includes RAM (Random Access Memory) or ROM (Read Only Memory). RAM includes SRAM (Static RAM) or DRAM (Dynamic RAM), and ROM includes EEPROM (Electrically Erasable Programmable ROM). The memory 102 stores the control program of the control apparatus 10, information necessary for operation, or operation results.

The control unit 103 includes processors such as a CPU (Central Processing Unit), GPU (Graphics Processing Unit), or dedicated circuits such as FPGA (Field-Programmable Gate Array) and ASIC (Application-Specific Integrated Circuit), and executes information processing of the control apparatus 10.

The input interface 105 is equipped with a microphone, capacitive keys, touch screens, pointing devices, or physical switches such as physical keys and joysticks, and accepts user operations, sending input information corresponding to the operations to the control unit 103.

The output interface 106 is equipped with a speaker or display. The display includes an LCD (Liquid Crystal Display) or organic EL (Organic Electroluminescence) and outputs the processing results of the control unit 103.

The mobile object 12 is a traveling robot equipped with a mechanism for transporting cargo and a traveling mechanism that includes wheels, and has a communication interface 121, control unit 123, sensor unit 127, and drive mechanism 128. The communication interface 121 supports communication standards such as wired LAN, wireless LAN, LTE, 4G, and 5G, and performs information communication with the control apparatus 10. The control unit 123 includes processors such as a CPU or dedicated circuits such as ASIC, and integrally controls the operation of the mobile object 12 while communicating with the control apparatus 10 via the communication interface 121. The sensor unit 127 includes an accelerometer, gyro sensor, distance sensor, camera, GPS (Global Positioning System) module, etc., and acquires information such as detection results regarding the surrounding environment, the motion state of the mobile object 12, captured images of the surrounding environment, and the current position of the mobile object 12, sending it to the control unit 103. The camera of the sensor unit 127 is installed in a position that can capture the environment in front of the mobile object 12 when it moves. The control unit 103 sends captured images and other data to the control apparatus 10 via the communication interface 121 and controls the operation of the drive mechanism 128 based on instructions from the control apparatus 10. The drive mechanism 128 includes wheels for traveling and motors and actuators that drive the wheels, realizing operations such as forward, backward, and turning of the mobile object 12 based on instructions from the control unit 123. Power is supplied from a battery mounted on the mobile object 12 to each of these components.

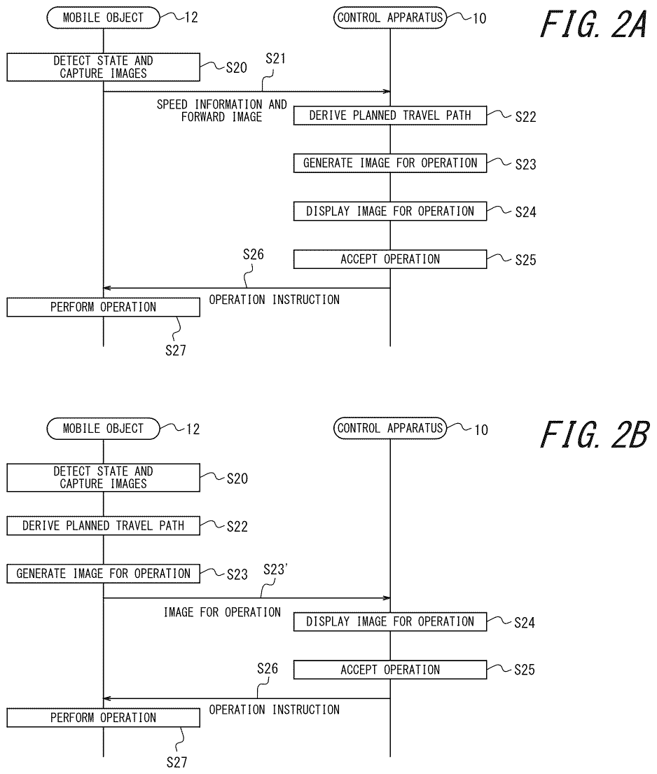

FIG. 2A is a sequence diagram illustrating an example of the operation procedures of the remote control system 1. FIG. 2A shows an example of the procedures related to the cooperative operation of the mobile object 12 and the control apparatus 10, executed at any cycle when the mobile object 12 moves, for example, at a cycle of several tens of microseconds.

The mobile object 12 detects and captures the state of the mobile object 12 in the traveling environment (S20) and sends information including speed information and a forward image to the control apparatus 10 (S21). Under the control of the control unit 123, the sensor unit 127 of the mobile object 12 detects the acceleration, movement speed, current position, etc., of the mobile object 12, and captures the surrounding environment including the forward direction. The control unit 123 sends information including speed information indicating the movement speed of the mobile object 12 and the forward image via the communication interface 121.

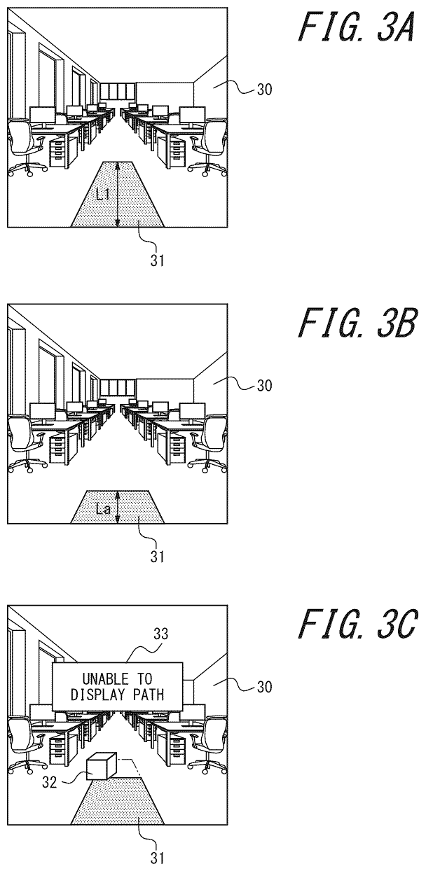

Then, the control apparatus 10 derives the planned travel path of the mobile object 12 based on the information obtained from the mobile object 12 (S22), generates an image for operation (S23), and displays the image for operation to the user (S24). In the control apparatus 10, the control unit 103 performs processing such as noise removal and distortion correction on the forward image of the mobile object 12, and identification processing of various objects reflected in the image. Additionally, the control unit 103 derives the planned travel path, generates a marker image indicating the planned travel path, and superimposes the marker image on the forward image to generate the image for operation. Then, the controller 103 displays the image for operation on the display of the output interface 106. A schematic example of the image for operation is shown in FIG. 3A. FIG. 3A is an example of an image for operation in which a marker image 31 indicating the planned travel path of the mobile object 12 is superimposed on the forward image 30 of the mobile object 12. This forward image 30 includes an image of the indoor environment of an office captured by the mobile object 12 moving within the office. The planned travel path is displayed as a marker image 31 extending forward in the travel direction of the mobile object 12 moving through the corridor.

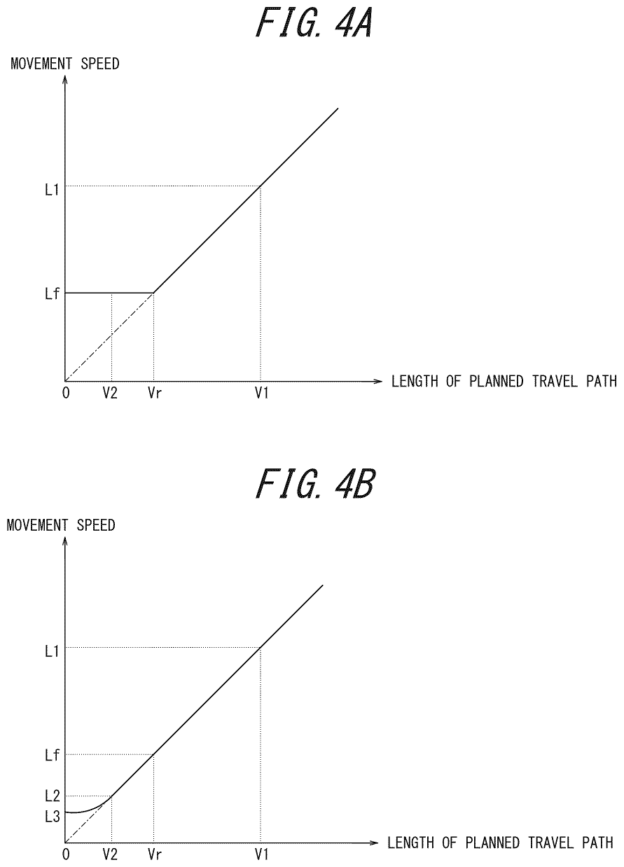

In this embodiment, when generating the marker image 31, the controller 103 changes the length of the planned travel path, that is, the distance L1 to the front end of the marker image 31, according to the speed of the mobile object 12. For example, as shown in the relationship between movement speed and planned travel path length in FIG. 4A, when the movement speed is greater than an arbitrary reference speed Vr (for example, 0.5 to 1 meter per second), the controller 103 dynamically linearly changes the planned travel path length L1 according to the movement speed V1. That is, the position of the tip of the planned travel path length L1 corresponds to the position that the mobile object 12 will reach after a certain time has elapsed, for example, after 1 second, when moving at the movement speed V1. The controller 103 can derive the planned travel path length corresponding to the movement speed using any formula or table data. On the other hand, when the movement speed is less than or equal to the reference speed Vr, the controller 103 fixes the planned travel path length to Lf. Here, the planned travel path length Lf corresponds to the position that the mobile object 12 will reach after 1 second when moving at the reference speed Vr. As a variation, as shown in FIG. 4B, the controller 103 may change the planned travel path length so that it gradually decreases as the movement speed decreases below the reference speed Vr, for example, so that the planned travel path length L2 corresponding to the movement speed V2 gradually decreases toward the intercept planned travel path length L3. By doing so, an image for operation like that shown in FIG. 3B is generated and displayed. FIG. 3B shows an example in which the marker image 31 of the planned travel path length Lf is superimposed on the forward image 30 during the deceleration of the mobile object 12, corresponding to the change pattern of the planned travel path length shown in FIG. 4A.

Returning to FIG. 2A, the control apparatus 10 accepts operations performed by the user based on the image for operation (S25) and sends operation instructions to the mobile object 12 based on the operations (S26). The controller 103 generates operation instructions corresponding to the user's operations on the input interface 105 and sends the operation instructions via the communication interface 121. The operation instructions are instructions for actions such as acceleration, deceleration, stopping, or turning. Then, the mobile object 12 performs actions corresponding to the operation instructions, that is, executes acceleration, deceleration, stopping, turning, etc. (S27).

By presenting the image for operation to the user through the above procedure, the user can perform remote control while checking the front of the mobile object 12. In that case, if the planned travel path length is linearly changed according to the movement speed over the entire range of the movement speed of the mobile object 12, when the mobile object 12 moves slowly or alternates between stopping and moving in a crowded corridor, the marker image of the planned travel path shown in the image for operation may become extremely short or not displayed, which may hinder the user's ability to foresee the planned travel path of the mobile object 12. In this regard, even when the mobile object 12 moves or stops at a speed lower than a certain level, by displaying a planned travel path of a certain length, the predictability of the planned travel path during user operation is ensured.

When generating the marker image 31 indicating the planned travel path in the control apparatus 10, the controller 103 can correspond the width of the marker image 31 in the lateral direction of the drawing to the width occupied by the mobile object 12 during movement. For example, the memory 102 stores information in advance to identify the area that the mobile object 12 may occupy during movement in the captured image, based on the installation position and angle of view of the camera of the mobile object 12, and using this information, the controller 103 can generate the width of the marker image 31 corresponding to the width of the mobile object 12. By doing so, the operability for the user is further improved.

Also, when transitioning from the operation image of FIG. 3A to the operation image of FIG. 3B due to fluctuations in the movement speed of the mobile object 12, since the fluctuation of the planned travel path length stops, the controller 103 can, for example, display or output audio such as “low-speed operation” to reduce user confusion.

In the variation example, when an obstacle is recognized at a position interfering with the marker image 31 on the planned travel path, it is possible to set the length of the marker image 31 to the position of the obstacle and include information notifying the presence of the obstacle in the operation image. For example, as shown in the operation image example of FIG. 3C, when the forward image 30 includes the obstacle 32, the controller 103 generates and superimposes the marker image 31 up to the position of the obstacle 32, and may superimpose a message 33 such as “unable to display path” on the operation image. The message 33 may be outputted by audio.

In a further variation example, as shown in FIG. 2B, the controller 123 of the mobile object 12 performs planned travel path derivation (S22) and operation image generation (S23), and sends the operation image from the mobile object 12 to the control apparatus 10 (S23′). Then, the controller 103 of the control apparatus 10 outputs the received operation image to the output interface 106 and displays it on the output interface 106. Alternatively, the mobile object 12 may perform travel path derivation and send the result along with the forward image to the control apparatus 10, where the controller 103 of the control apparatus 10 generates and outputs the operation image. By doing so, load distribution for image processing and the like becomes possible.

While the embodiment has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A control apparatus comprising:
a communication interface configured to communicate with a mobile object; and
a controller configured to output information for displaying a planned travel path of the mobile object superimposed on a captured image ahead in a travel direction of the mobile object,
wherein a length of the planned travel path corresponds to a first movement speed when a movement speed of the mobile object is the first movement speed, and is a predetermined length when the movement speed is a second movement speed that is less than the first movement speed.

2. The control apparatus according to claim 1, wherein the planned travel path has a width corresponding to a width of the mobile object with respect to the travel direction.

3. The control apparatus according to claim 1, wherein the controller is configured to output a predetermined notification when the captured image includes an object interfering with the planned travel path.

4. The control apparatus according to claim 1, further comprising:
an input interface configured to accept an instruction for operating the mobile object,
wherein the controller is configured to transmit, to the mobile object, information to control movement of the mobile object according to the instruction.
